(19) United States
(12) Patent Application Publication
(10) Pub. No.: US 2014/0002879 A1
(43) Pub. Date: Jan. 2, 2014

(54) ILLUMINATION CONTROLLABLE FILM

(71) Applicant: Toshimi Fukui, Otsu City (JP)

(72) Inventor: Toshimi Fukui, Otsu City (JP)

(73) Assignee: EMPIRE TECHNOLOGY DEVELOPMENT LLC, Wilmington, DE (US)

(21) Appl. No.: 13/702,991

(22) PCT Filed: Jun. 27, 2012
(86) PCT No.: PCT/US12/44322

§ 371 Date: Dec. 7, 2012

(51) Int. Cl. G02F 1/01; G02F 1/19

(52) U.S. Cl. CPC G02F 1/0126; G02F 1/19
USPC 359/243; 359/241; 359/244; 359/240

(57) ABSTRACT

Some embodiments provided herein relate to filters for electromagnetic radiation. Some embodiments provided herein relate to phototunable compounds for which at least one optical characteristic can be changed. Some embodiments herein relate to methods of manipulating a wavelength of electromagnetic radiation.

### FIELD

Embodiments herein relate generally to films for controlling characteristics of electromagnetic radiation.

### BACKGROUND

A variety of lighting technologies are available for consumers. Light emitting diode (“LED”) based lighting is becoming a relatively commonly employed light source.

### SUMMARY

In some embodiments, a light filter is provided. The light filter can include a substrate, and a least one refractive-index changeable compound on the substrate. The refractive-index changeable compound has a first optical characteristic that changes to a second optical characteristic through a first photoinduced structural modification.

In some embodiments, an illuminated device is provided. The device can include a phototunable compound. The phototunable compound has a first optical characteristic that changes to a second optical characteristic through photoinduced structural modification. The device can further include a source of electromagnetic radiation positioned to provide light to the phototunable compound.

In some embodiments, a method of manipulating at least one wavelength of visible-wavelength radiation is provided. The method can include controlling an optical property of a phototunable compound at a first wavelength of visible light by irradiating the phototunable compound with at least one wavelength of ultraviolet radiation. The phototunable compound is positioned on top of a substrate and the substrate is substantially transparent to ultraviolet radiation and visible light.

In some embodiments, a visible wavelength light manipulator is provided. The visible wavelength light manipulator can include a substrate that is substantially transparent to electromagnetic radiation traveling in at least one incident direction. The visible wavelength light manipulator can also include at least one refractive-index changeable molecule covalently bonded to a surface of the substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a drawing illustrating some embodiments of a light filter configured to scatter light.

FIG. 1B is a drawing illustrating some embodiments of a light filter configured to reflect light.

FIG. 2A is a drawing illustrating some embodiments of conversion of a trans isomer to a cis isomer.

FIG. 2B is a drawing illustrating some embodiments of conversion of a trans isomer to a cis isomer.

FIGS. 3A and 3B are drawings illustrating some embodiments of an embodiment of a light filter.

FIG. 4 is a flow diagram illustrating a method of manipulating at least one wavelength of visible wavelength radiation.

FIG. 5 is a drawing illustrating some embodiments of attaching a refractive-index changeable molecule to a silanized surface of a substrate.

FIG. 6A is a graph illustrating estimated values of changes in diameter of scattering domains formed in liquid layer and linear transmittance. The values in the graphs denote volume fractions of domains formed in the films. Wavelength: 589 nm.

FIG. 6B is a graph illustrating estimated values of changes in linear transmittance due to introduction of domains into liquid phase at each wavelength. The values in the graphs denote diameters of domains formed in the films.

FIG. 7A is a graph illustrating estimated values of changes in reflectance by modulation of orientation of liquid crystal (“LC”) molecule layer. Refractive index change between before and after irradiation of LC layer with light: from 1.70 to 1.60. Refractive index of substrate: 1.5.

FIG. 7B is a graph illustrating estimated values of changes in reflectance by modulation of orientation of liquid crystal molecule layer. Refractive index change between before and after irradiation of LC layer with light: from 1.70 to 1.60. Refractive index of substrate: 1.6

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

While modern lighting systems can have numerous advantages, such as relatively small size and/or low energy costs, frequently, the smaller size can mean lower intensity of light. Furthermore, the smaller size can be problematic, in that it lends itself to point sources of light that are uncomfortable and/or undesirable in some situations. As outlined herein, it has been appreciated that the ability to provide an illumination controllable film, in front of a light source (including for example, a point source of light from an LED), can allow for one to redirect, control, and/or generally manipulate one or more point sources of light, to create a more desirable lighting experience. The illumination controllable films provided herein include a refractive-index changeable compound, which can exist in at least two different states, with each state having different optical properties. By controlling the state of the refractive-index changeable compound, one can control the optical properties of the film itself, and thus manipulate light from a light source. Furthermore, the state of the refractive-index changeable compound provided herein can be controlled by electromagnetic energy of wavelengths, which can be different from those wavelengths of light that are being manipulated. For example, in some embodiments, the refractive-index changeable compound is in a first state, which allows visible light to pass through the film without significant manipulation. The refractive-index changeable compound is then exposed to UV light, which alters the state of the refractive-index changeable compound (for example, by altering its configuration), which alters the optical properties of the molecule(s) in regard to visible light, so that the film will then act as a filter for visible light, and thus, manipulates the visible in a desired manner. Thus, in some embodiments, a layer or film is provided which can, in a state-dependent manner, selectively filter or not filter visible light, and the state of the molecules in the layer or film can be controlled by ultraviolet light. Provided herein are light filters, compositions, kits, and methods of use relating to such aspects.

In some embodiments, light filters are provided. The light filter can include a substrate. The light filter can include at least one a refractive-index changeable compound on the substrate. In some embodiments, the at least one refractive-index changeable compound has a first optical characteristic that changes to a second optical characteristic through a first photoinduced structural modification. In some embodiments, the second optical characteristic can change to the first optical characteristic through a second photoinduced structural modification.

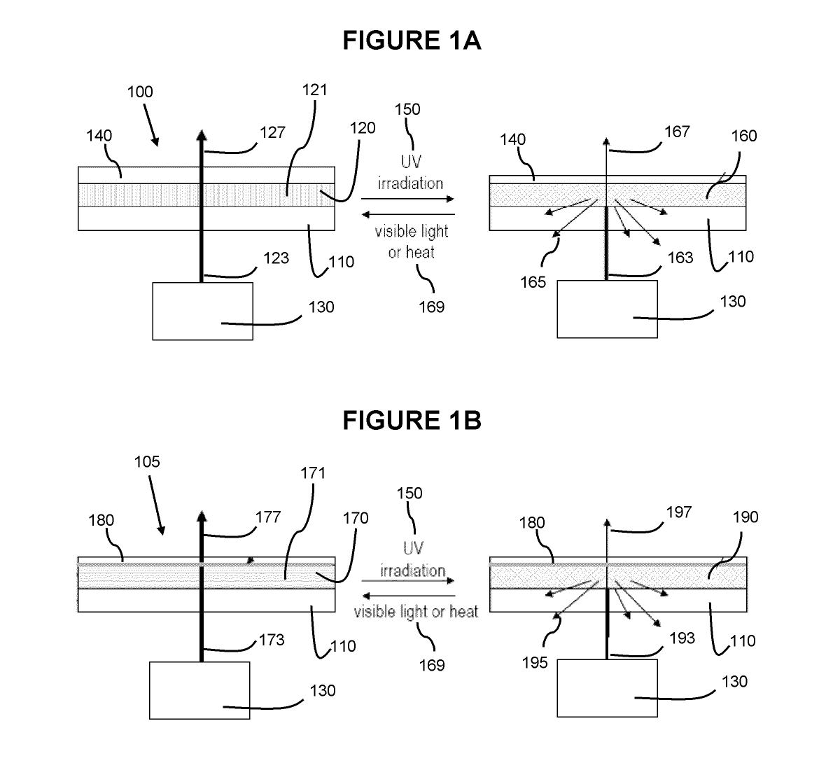

FIG. 1A illustrates some embodiments of a light filter 100 configured to scatter light. FIG. 1B illustrates some embodiments of a light filter 105 configured to reflect light.

As illustrated in FIG. 1A, in some embodiments, a filter configured to scatter light 100 can include a substrate 110. In some embodiments, the filter can include a refractive-index changeable compound 120 on the substrate. In some embodiments, the refractive-index changeable compound 120 can be in a first configuration 121, such as a substantially anisotropic configuration. In some embodiments, the refractive-index changeable compound 120 can be oriented vertically relative to the substrate. In some embodiments, the light is provided by an illumination source 130.

In some embodiments, the filter can include an optional first layer 140, positioned so that the refractive-index changeable compound 120 is between the substrate 110 and the first layer 140.

In some embodiments, when the refractive-index changeable compound is exposed to UV irradiation 150 it will transition the refractive-index changeable compound to a second configuration 160, such as a substantially isotropic configuration. In some embodiments, when light 163 is transmitted through the substrate 110, the light is scattered 165 by the substantially isotropic refractive-index changeable compound 160. Following the transition, less light 167 is transmitted through the filter 100 relative to the amount of light transmitted through the filter 127 when the refractive-index changeable compound was substantially in its previous state 120 (for example, anisotropic). In some embodiments, the substantially isotropic refractive-index changeable compound 160 can be shifted back to a substantially isotropic configuration 120 by visible light or heat 169.

Additional layers and/or variations are also contemplated herein. For example, FIG. 1B provides some embodiments of a filter configured to reflect light 105. The filter configured to reflect light 105 can include a substrate 110. The filter can include a refractive-index changeable compound 170 on the substrate 110. In some embodiments, the refractive-index changeable compound 170 can be in a first state 171 (for example a substantially anisotropic configuration). In some embodiments, the refractive-index changeable compound 170 can be oriented horizontally relative to the substrate. An initial amount of light 173 is transmitted through the substrate 110 and through the refractive-index changeable compound 170, and can then leave the filter as exiting light 177. In some embodiments, light can be provided by an illumination source 130. In some embodiments, the device can include a high-refractive-index layer 180, positioned so that the refractive-index changeable compound 170 is between the substrate 110 and the high-refractive-index layer 180. When the refractive-index changeable 170 compound is exposed to UV irradiation 150, it shifts the refractive-index changeable compound to a second state 190 (e.g., a substantially isotropic configuration). In some embodiments, when an initial amount of light 193 is then passed transmitted through the substrate 110 and into the refractive-index changeable compound, the light is reflected 195 at the interface of the refractive-index changeable compound 190 and the high-refractive-index 180 layer. Thus, less light 197 is transmitted through the filter relative to the amount of light 177 transmitted through the filter when the refractive-index changeable compound is in the first state (for example, substantially anisotropic). In some embodiments, the substantially isotropic refractive-index changeable compound 190 can be shifted back to a substantially isotropic configuration by visible light or heat 169.

In some embodiments, the light filter can include a substrate and at least one refractive-index changeable compound on the substrate. In some embodiments, the refractive-index changeable compound can transition between substantial anisotropy and substantial isotropy. In some embodiments, the refractive-index changeable compound includes a molecule that isomerizes from a trans form to a cis form. The compound can be substantially anisotropic in the trans form, and substantially isotropic in the cis form. In some embodiments, the orientation of the compound can affect optical properties of the compound for at least one incident direction of light. In some embodiments, for example situations in which the substantially anisotropic compound is orientated substantially parallel to an incident direction of light, the refractive index increases when the compound becomes substantially isotropic. In some embodiments, for example in situations in which the compound is oriented substantially perpendicular to an incident direction of light, the refractive index decreases when the compound becomes substantially isotropic.

In some embodiments, the light filter is configured to scatter light. In some embodiments, when the light filter is configured to scatter light, light is transmitted through the substrate, and is scattered by the refractive-index changeable compound in the cis form.

In some embodiments, the light filter is configured to reflect light. In some embodiments, when the light filter is configured to reflect light, the filter further includes a high-refractive-index layer (for example, as shown in FIG. 1B above). In some embodiments, the high-refractive-index layer is positioned so that the refractive-index changeable compound is positioned between the high-refractive index layer and the source of light. This will allow for the light to be reflected at the interface between the refractive-index changeable compound in a substantially isotropic configuration and the high-refractive index layer.

Any of a variety of substrates can be used for various embodiments provided herein. In some embodiments, the substrate is substantially transparent for example a wavelength of visible light. In some embodiments, the substrate is at least about 60% transparent to electromagnetic radiation having ultraviolet and visible light.

In some embodiments, the substrate is substantially transparent to electromagnetic radiation traveling in at least one incident direction, for example substantially perpendicular to a surface of the substrate. In some embodiments, the substrate is a solid. In some embodiments, the substrate is substantially rigid. In some embodiments, the substrate is flexible. In some embodiments, the substrate includes a polymer. In some embodiments, the substrate is a glass.

In some embodiments, the substrate has a thickness of at least about 10 micrometers, for example about 10 to 1,000 micrometers, including ranges between any two of the listed values.

In some embodiments, the substrate has a refractive index that is less than or equal the refractive index of the refractive-index changeable compound. In some embodiments, the substrate has a refractive index of over than or equal to 1.4, for example, about 1.4 to 1.7.

In some embodiments, at least one surface of the substrate is silanized as described herein.

In some embodiments, the refractive index compound can have a first optical characteristic that changes to a second optical characteristic through a first photoinduced structural modification and/or alteration. The optical characteristic can include at least one of anisotropy, isotropy, and/or refractive index. The structural modification can include shifting between a cis configuration and trans configuration, for example, through photoinduced isomerization.

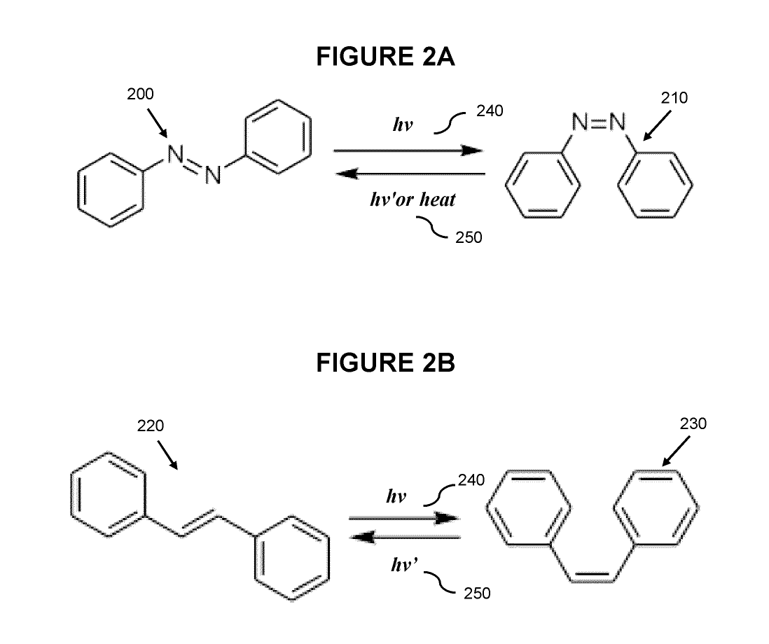

FIG. 2 illustrates some embodiments of refractive-index changeable compounds. The left side of FIG. 2A illustrates an azobenzene in a trans configuration 200. In some embodiments, the azobenzene shifts to a cis configuration 210 (right side). In some embodiments, the azobenzene shifts from a cis configuration 210 to a trans configuration 200. FIG. 2B illustrates some embodiments of a stilbene in a trans configuration 220. Upon exposure to UV radiation, the stilbene moiety isomerizes to a cis configuration 230. In some embodiments, the azobenzene can shift from a cis configuration 230 to a trans configuration 220 (for example upon exposure to visible light or heat 250. In some embodiments, the structural modification is a transition from a cis to a trans isomer. In some embodiments, the structural modification is a transition from a trans to a cis isomer.

In some embodiments, the refractive-index changeable compound can be any molecule that undergoes photoinduced isomerization. In some embodiments, the compound will also have a first optical characteristic in its first conformation and a second optical characteristic in its second conformation.

In some embodiment, the refractive-index changeable compound includes at least one of 9-demethylretinal, derivatives of 9-demethylretinal, an azobenzene, an azobenzene derivative, a stilbene, or a stilbene derivative. In some embodiments, the compound includes a molecule that is selected from one of Formula 1 or Formula 2.

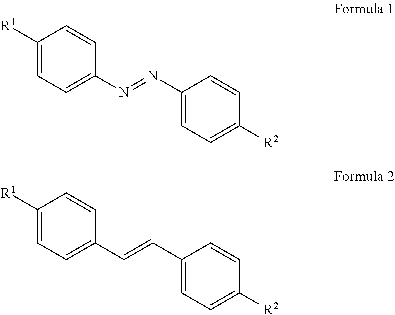

wherein R¹ and R² can each be independently selected from the group of at least one of the following: a hydrogen, an alkyl, an alkoxyl a hydroxyl, a hydroxylalkyl, a cyano and a silanol. In some embodiments, the refractive-index changeable compound includes two or more of the molecules listed herein. In some embodiments, R¹ and R² of Formulae 1 and/or 2 are all hydrogens. In some embodiments, R¹ of Formula 2 includes two hydroxyl groups and R² includes a single hydroxyl group. For example, in some embodiments, R¹ and R² is CₙH₂ₙ₊₁ (1=<n=<8, C₅H₁₁, C₄H₉, etc.), CₙH₂ₙ₊₁O (where 1=<n=<8, CH₃O, etc.), or CN.

In some embodiments, the refractive-index changeable compound can include the compound of Formula 3 or the compound of Formula 4:

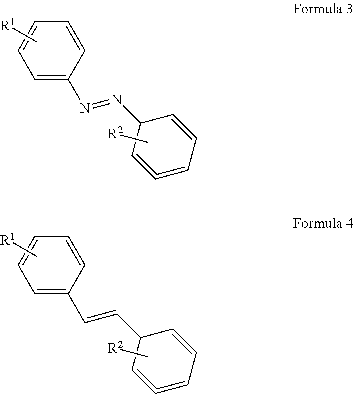

wherein R¹ and R² can each be independently selected from the group of at least one of the following: a hydrogen, an alkyl group (for example C₅H₁₁, C₄H₉, etc.), a hydroxyl, a hydroxylalkyl (for example OCH₃), a cyano, and a silanol. In some embodiments, the compound can be that for Formula 5 and/or Formula 6.

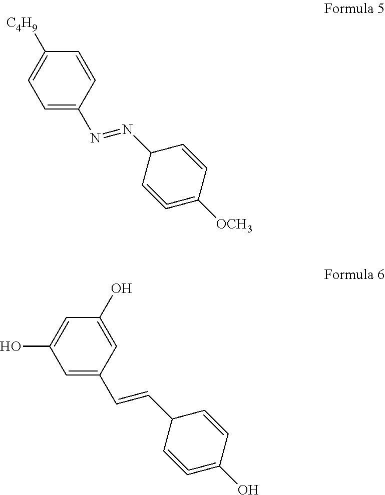

In some embodiments, the refractive-index changeable compound is, or is part of, a nematic crystal.

In some embodiments, additional molecule can be combined and/or mixed with the refractive-index changeable compound. For example, a molecule can be added that facilitates the formation of scattering centers, such as a molecule of Formulae 7 and/or 8.

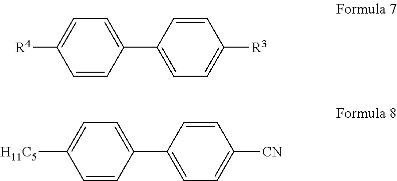

wherein R⁴ and R³ can be independently selected from the group of at least one of the following: a hydrogen, an alkyl, an alkoxyl, a hydroxyl, a hydroxylalkyl, a cyano, and a silanol group. For example, R³ and R⁴ is CₙH2ₙ₊₁ (1=<n=<8, C₅H₁₁, C₄H₉, etc.), CₙH₂ₙ₊₁O (1=<n=<8, CH₃O, etc.), or CN.

In some embodiments, the refractive-index changeable compound contacts the substrate. In some embodiments, the refractive-index changeable compound is spread over a surface of the substrate. In some embodiments, the refractive-index changeable compound is partially embedded in the substrate. In some embodiments, the refractive-index changeable compound is covalently bonded to the substrate. In some embodiments, the refractive-index changeable compound is covalently bonded to at least one silicon molecule, such as on a silanized surface of the substrate. In some embodiments the reactive-index changeable compound covers at least about 30% of a surface of a substrate, for example 30 to 100% of the surface.

In some embodiments, the reactive-index changeable compound forms a layer over the substrate. In some embodiments, the layer of the reactive-index changeable compound is at least about 10 nanometers thick, for example, about 10 to 20,000 nanometers, including ranges between any two of the listed values.

In some embodiments, for example when the reactive-index changeable compound is positioned vertically to the substrate, the layer of compound is about 100 nm to about 500,000 nm thick.

In some embodiments, for when the reactive-index changeable compound is positioned horizontally to the substrate, the layer of compound is about 20 nm to about 1,000 nm thick.

In some embodiments, the refractive-index changeable compound has a first optical characteristic that can change to a second optical characteristic through a first photoinduced structural modification. In some embodiments, the second optical characteristic can revert to the first optical characteristic through a second photoinduced structural modification. In some embodiments, the first optical characteristic includes a first level of anisotropy. In some embodiments, the second optical characteristic includes a second level of anisotropy. In some embodiments, the first optical characteristic includes substantial anisotropy, and the second optical characteristic includes substantial isotropy.

In some embodiments, a cis to trans isomerization of the refractive-index changeable compound alters the level of anisotropy of the compound. In some embodiments, when the molecules of the compound are substantially in the trans form, the compound is substantially anisotropic. In some embodiments, when the molecules of the compound are substantially in the cis form, the compound is substantially isotropic.

In some embodiments, the first optical characteristic includes a first refractive index and the second optical characteristic includes a second refractive index that is different from the first refractive index. In some embodiments, the refractive index is a refractive index for light having a visible wavelength of light, for example, from about 390 to about 750. In some embodiments, the refractive index is for light traveling at an incident angle that is substantially perpendicular to a surface of the substrate. In some embodiments, the first refractive index is about the same as the substrate or near enough for light having a wavelength from about 390 to about 750, for example about 1.45 to 1.6. In some embodiments, the second refractive index is higher than the first refractive index. In some embodiments, the second refractive index is lower than the first refractive index. In some embodiments, whether the second refractive index is higher or lower than the first refractive index depends on the orientation of the refractive-index changeable compound relative to the incident angle of light. In some embodiments, the difference between the first refractive index and the second refractive index is at least about 0.01, for example about 0.01, to 0.2 including ranges between any two of the listed values.

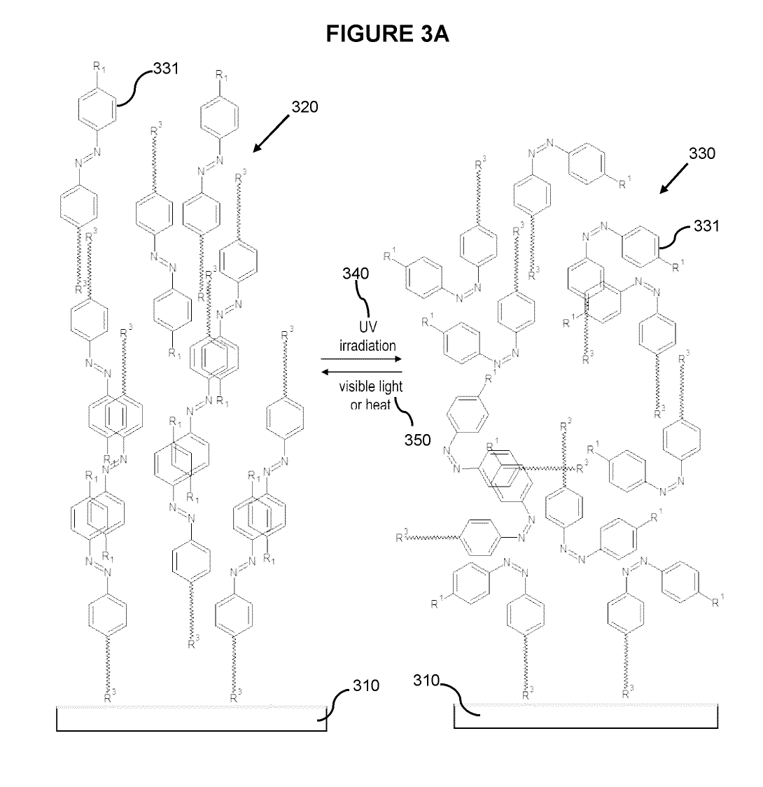

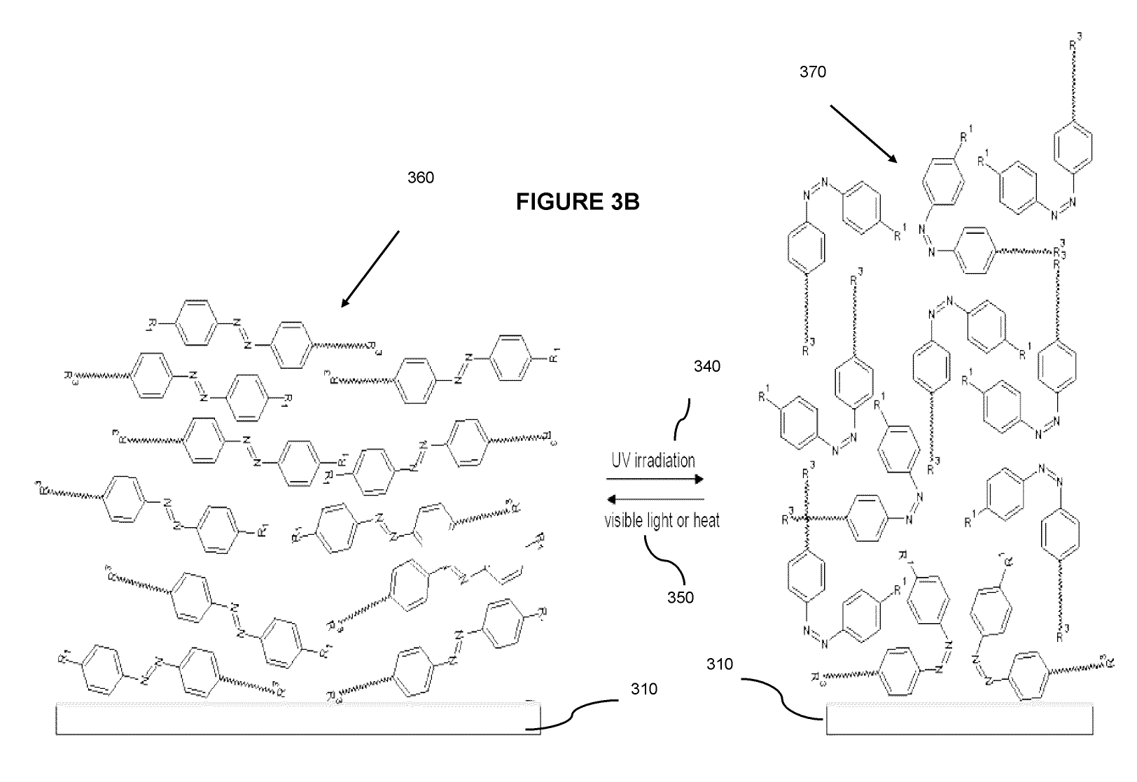

In some embodiments, when the refractive-index changeable compound is substantially anisotropic, it is positioned vertically with respect to the substrate. In some embodiments, when the refractive-index changeable compound is substantially anisotropic, at least about 70% of the molecules of the refractive-index changeable compound are vertical to the substrate. FIG. 3A illustrates some embodiments of a substrate 310, and refractive-index changeable compounds 331 in a trans configuration (left side), that is substantially vertical to the substrate when anisotropic 320. When the molecules shift to a cis configuration, the layer becomes substantially isotropic 330. For light transmitted at an incident angle, (which includes an angle substantially perpendicular to the substrate) the isotropic arrangement can have a lower refractive index than the anisotropic arrangement. The shift to become substantially isotropic can be induced by UV irradiation 340. A shift to become substantially anisotropic can be induced by visible light or heat 350. R³ can be independently selected from the group of at least one of the following: a hydrogen, an alkyl, an alkoxyl, a hydroxyl, a hydroxylalkyl, a cyano, and a silanol group, for example, R³ can be CₙH2ₙ₊₁ (1=<n=<8, C₅H₁₁, C₄H₉, etc.), CₙH₂ₙ₊₁O (1=<n=<8, CH₃O, etc.), or CN.

In some embodiments, when the refractive-index changeable compound is positioned vertically with respect to the substrate, the layer and/or compound can scatter light. In some embodiments, the refractive-index changeable compound can be positioned vertically with respect to the substrate, and can have substantially the same refractive index as the substrate, thus permitting the transmittance of light transmitted by the substrate. When the refractive-index changeable layer and/or compound changes to a substantially isotropic state, it can have a higher refractive than when in the anisotropic state, and thus a higher refractive index than the substrate. The substantially isotropic compound can thus scatter light transmitted by the substrate.

In some embodiments, when the refractive-index changeable compound is substantially anisotropic, it is positioned horizontally with respect to the substrate. In some embodiments, when the refractive-index changeable layer is substantially anisotropic, at least about 70% of the molecules of the refractive-index changeable compound are horizontal to the substrate. FIG. 3B illustrates some embodiments of a substrate 310 with refractive-index changeable molecules 361 in a trans configuration (left side), which are substantially horizontal to the substrate when anisotropic 360. The molecules of the compound can shift to a cis configuration (right side) to become substantially isotropic 370. For light transmitted at an incident angle, (which can be an angle substantially perpendicular to the substrate) the isotropic arrangement can have a lower refractive index than the anisotropic arrangement. A shift to become substantially isotropic can be induced by UV irradiation 340. A shift to become substantially anisotropic can be induced by visible light or heat 350.

In some embodiments, the layer transmits, refracts, and/or reflects electromagnetic radiation in the visible spectrum. In some embodiments, the filter is configured to transmit, refract, and or reflect electromagnetic radiation having a wavelength of about 390 nanometers to about 800 nanometers including ranges between any two of the listed values. In some embodiments, the filter is configured to transmit, refract, and or reflect two or more substantially different wavelengths electromagnetic radiation.

In some embodiments, a photoinduced modification changes the optical characteristic of the refractive-index changeable compound. In some embodiments, the photoinduced modification includes cis-trans isomerization. In some embodiments, the first photodinduced modification includes isomerization from a cis form to a trans form. In some embodiments, the second photodinduced modification includes isomerization from a trans form to a cis form.

In some embodiments, the photoinduced structural modification includes isomerization of a population of the molecules of the refractive-index changeable compound. In some embodiments, the photoinduced structural modification includes isomerization of substantially all of the refractive-index changeable molecules. In some embodiments, the photoinduced structural modification includes isomerization of some, but not all of the refractive-index changeable molecules. In some embodiments, the photoinduced structural modification includes isomerization at least about 10% of the molecules of refractive-index changeable compound

In some embodiments, one or more type of energy can induce the structural modification. In some embodiments, the structural modification is induced by ultraviolet electromagnetic radiation. In some embodiments, the ultraviolet radiation has a wavelength of no more than about 400 nm, for example about 250 to 400 nm.

In some embodiments, the structural modification of the refractive-index changeable compound is induced by heating the compound. In some embodiments, the structural modification is induced by providing at least about room temperature to about 40 degree Celsius.

In some embodiments, the photoinduced structural modification is induced by visible radiation having a wavelength of at least about 370 nm, for example about 370 to 620 nm, including ranges between any two of the listed values.

In some embodiments, the first photoinduced structural modification is induced by ultraviolet radiation to change the first optical characteristic of the refractive-index changeable compound to the second optical characteristic. In some embodiments, the second structural modification (to revert the compound back to the first conformation) is induced by heating the compound as described herein. In some embodiments, the second structural modification is induced by one of visible or infrared electromagnetic radiation. In some embodiments, the second structural modification thus reverts the second optical characteristic of the refractive-index changeable compound to the first optical characteristic.

In some embodiments, the filter or other device includes at least one additional optional layer. In some embodiments, the additional optional layer is positioned adjacent to the substrate, adjacent to the refractive-index changeable compound, adjacent to the high-refractive-index layer, and/or elsewhere in the device. In some embodiments, two or more additional optional layers are included. In some embodiments, an additional optional layer has a thickness of at least about 20 nanometers thick, for example, at least about 20 to 1,000 nanometers.

In some embodiments, for example in some embodiments in which the filter is configured to reflect light, the filter includes an optional high-refractive index layer that is positioned so that the refractive-index changeable compound is positioned between the substrate and the high-refractive-index layer. In some embodiments, the high-refractive index layer is positioned distal to light source, for example, behind the refractive index changeable compound. In some embodiments, the high-refractive index layer is positioned adjacent to the refractive index changeable compound. FIG. 1B illustrates an optional high-refractive index layer 180. The high-refractive-index layer can have a refractive index greater than the refractive index of the substrate, and greater than the first refractive index and second refractive index of the refractive-index changeable compound. The second refractive index of the refractive-index changeable compound can be less than the first refractive index. In some embodiments, the high-refractive-index layer can have a refractive index at least about 5% greater than the refractive index of the first refractive index of the refractive-index changeable compound, for example, about 5 to 60% greater.

In some embodiments, the high-refractive index layer has a refractive index that is at least about 1.5, for example, about 1.5 to 2.6. In some embodiments, the high-refractive-index layer includes a colorless material. In some embodiments, the high-refractive-index layer includes titanium oxide, aluminum oxide, zirconium oxide, tin oxide, Ta₂O₅, Nb₂O₅, diamond, diamond like carbon (DLC) or a combination of at least two of the listed compounds.

In some embodiments, the high-refractive-index layer is provided so that the filter reflects light. The high-refractive-index layer can be provided along with a refractive-index changeable compound that is substantially horizontal to the substrate. With reference to FIG. 1B, in some embodiments, the refractive index of the substrate 110 can be less than the refractive index of the substantially anisotropic horizontally oriented refractive-index changeable compound 170, which can be less than the refractive index of the high-refractive-index layer 180. Thus, the filter in the substantially anisotropic configuration can transmit light. When the refractive-index changeable compound changes to a substantially isotropic configuration 190, its refractive index can decrease. The refractive index of the substrate can be less than or equal to the refractive index of the substantially isotropic horizontally oriented refractive-index changeable compound 190, which can be less than the refractive index of the high-refractive-index layer 180. The interface of the refractive-index changeable compound and the high-refractive-index layer can refract light. Thus, when the refractive-index changeable compound is in a substantially isotropic configuration, the filter reflects light transmitted though the substrate.

In some embodiments, for example in some embodiments in which the filter is configured to scatter light, the filter includes an optional first layer that is positioned so that the refractive-index changeable compound is positioned between the substrate and the first layer. FIG. 1A illustrates an optional first layer 140. In some embodiments, the first layer has a refractive index that is substantially the same as the refractive index of the substrate. In some embodiments, the refractive index of the first layer is within about ±20% of the refractive index of the substrate, for example about ±20%.

In some embodiments, an illuminating device is provided. The illuminating device can include a phototunable compound (for example, any of the refractive index changeable compounds provided herein), in which the phototunable compound has a first optical characteristic that changes to a second optical characteristic through photoinduced structural modification. The illuminating device can further include a source of electromagnetic radiation positioned to provide light to the phototunable compound. In some embodiments, the filter is configured to transmit, refract, and/or reflect electromagnetic radiation in the visible spectrum.

In some embodiments, the source of electromagnetic radiation of the illuminating device includes a light emitting diode. In some embodiments, the light emitting diode includes a substantially planar light emitting diode. In some embodiments, the source of electromagnetic radiation is in optical communication with the substrate. In some embodiments, the substrate includes one or more surfaces of the source of electromagnetic radiation, for example at least one surface of a planar light emitting diode. In some embodiments, the source of electromagnetic radiation provides visible light as described herein positioned such that it provides light at least on an angle that is incident to the substrate. In some embodiments, the incident angle is substantially perpendicular to a surface of the substrate. In some embodiments, the incident angle is more than the critical angle. In some embodiments, the illuminating device includes two or more sources of electromagnetic radiation.

In some embodiments, the device also includes a source of UV radiation such that it can irradiate the substrate and/or the refractive-index changeable compound. In some embodiments, the device includes a filter so as to control UV irradiation selectively over visible light irradiation of the refractive-index changeable compound (or phototunable material). In some embodiments, the source of UV radiation is configured to be on at all times, so that any conversion of the compounds via visible light will be rapidly converted back to a UV biased state. In some embodiments, the device includes a heating element, so that any conversion of the compounds via visible light will be rapidly converted back to a heat applied state (for example, the left hand side of FIGS. 1A, 1B, and 3A).

In some embodiments, a method of manipulating at least one wavelength of visible wavelength radiation is provided. The method can include controlling an optical property of a phototunable compound at a first wavelength of visible light. The optical property can be controlled by irradiating the phototunable compound with at least one wavelength of ultraviolet radiation. In some embodiments, the phototunable compound is positioned on top of a substrate as described herein. In some embodiments, the substrate is substantially transparent to ultraviolet radiation and visible light as described herein.

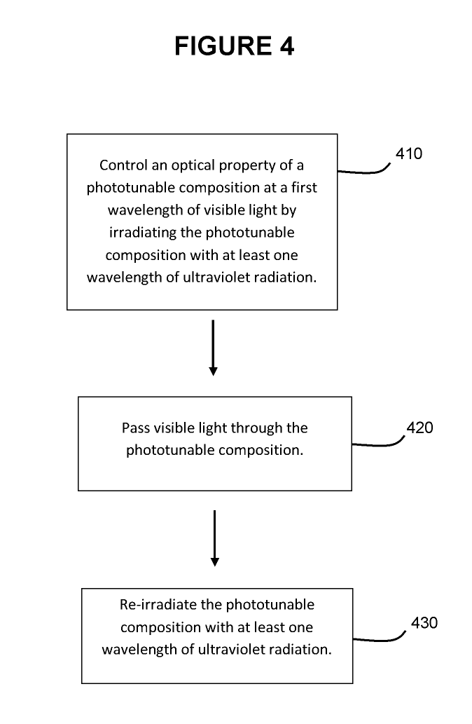

FIG. 4 is a flow diagram illustrating a method of manipulating at least one wavelength of visible radiation. The method includes controlling an optical property of a phototunable compound at a first wavelength of visible light by irradiating the phototunable compound with at least one wavelength of ultraviolet radiation 410. In some embodiments, the phototunable compound is positioned on top of a substrate. Furthermore, in some embodiments, the substrate is substantially transparent to ultraviolet radiation and visible light. In some embodiments, one can manipulate the visible light as one is passing the UV light through the composition. In some embodiments, one can first control the optical property 410 and then pass visible light through the composition 420, thereby manipulating the visible light. In some embodiments, one can optionally re irradiate the phototunable compound with at least one wavelength of UV energy 430 (or, for example, heat). One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some embodiments, the method includes controlling the optical property by irradiating the phototunable compound as described herein. In some embodiments, the method includes controlling the optical property by inducing a photoinduced structural modification as described herein. In some embodiments, the method includes irradiating the phototunable compound as described herein, thus inducing a structural modification that changes at least one optical property of the phototunable compound, for example a cis to trans isomerization, or a trans to cis isomerization. In some embodiments, the method includes irradiating the phototunable compound with ultraviolet radiation as described herein. In some embodiments, the method includes irradiating the phototunable compound with visible light as described herein. In some embodiments, the method includes irradiating the phototunable compound with infrared radiation as described herein. In some embodiments the radiation is provided by an illumination source as described herein. In some embodiments, the radiation is provided by a second source, for example a handheld device. In some embodiments, the method includes heating the phototunable compound as described herein, thus inducing a structural modification that changes at least one optical property of the phototunable compound.

In some embodiments, the optical property of the phototunable compound includes a refractive index, as described herein. In some embodiments, the optical property of the phototunable compound includes a level of anisotropy, as described herein. In some embodiments, the phototunable compound includes a refractive-index changeable compound. Thus, the composition is both tunable by radiation and, when tuned, alters is refractive index. In some embodiments, the refractive-index changeable molecule includes a phototunable compound. Thus, the molecule alters is refractive index when exposed to radiation.

In some embodiments, controlling an optical property of the phototunable compound includes altering an amountof scattering by the phototunable compound.

In some embodiments, the phototunable compound and/or layer is changed from a configuration of substantial anisotropy to a configuration of substantial isotropy as described herein, for example by ultraviolet irradiation. In some embodiments, the substantially isotropic phototunable compound has a higher refractive index than the substrate or the configuration of substantial anisotropy. The visible light can be transmitted through the substrate, and can be scattered by the substantially isotropic phototunable compound. Thus, the percent transmittance of light through the substantially isotropic phototunable compound is less than the percent transmittance of light through the substantially anisotropic phototunable compound. In some embodiments, the percent transmittance through the substantially isotropic phtototunable composition is at least about 1% less than through the anisotropic phototunable compound, for example about 1 to 30%.

In some embodiments, the method includes reflecting light from the light source (for example, light that passes through the substrate). A high-refractive-index layer can be provided as described herein (for example FIG. 1B), and positioned so that the phototunable compound is positioned between the high-refractive-index layer and the substrate (or the source of radiation). The phototunable compound can be positioned substantially horizontal to the substrate. In some embodiments, the phototunable compound is changed from a configuration of substantial anisotropy to a configuration of substantial isotropy as described herein, for example by ultraviolet irradiation. In some embodiments, the visible light can be transmitted through the substrate, and can be reflected at the interface of the substantially isotropic phototunable compound and the high-refractive-index layer.

In some embodiments, the method includes configuring the filter to have a percent transmittance through the substantially isotropic phtototunable composition is at least about 1% less than through the anisotropic phototunable compound, for example about 1 to 10%.

In some embodiments, the method includes reversibly changing an optical property of the phototunable compound. In some embodiments, a first irradiation, for example ultraviolet radiation, modulates an optical property of the phototunable compound from a first state to a second state as described herein. In some embodiments, a second irradiation, for example visible light or infrared radiation, is provided to the phototunable compound described herein to modulate the optical property of the phototunable compound from the second state to a first state as described herein. In some embodiments, heating modulates the optical property of the phototunable compound from the second state to a first state as described herein. For example, ultraviolet irradiation can be provided to the phototunable compound as described herein to induce a trans-to-cis isomerization of the phototunable compound as described herein, thus changing the level of anisotropy and/or refractive index of the composition. Visible light irradiation can induce a cis-to-trans isomerization of the phototunable compound as described herein, thus reverting the level of anisotropy and refractive index of the composition to levels substantially similar to levels as before.

In some embodiments, a visible wavelength light manipulator is provided. The visible wavelength light manipulator can include a substrate that is substantially transparent to electromagnetic radiation traveling in at least one incident direction. The visible wavelength light manipulator can also include at least one refractive-index changeable molecule covalently bonded to a surface of the substrate.

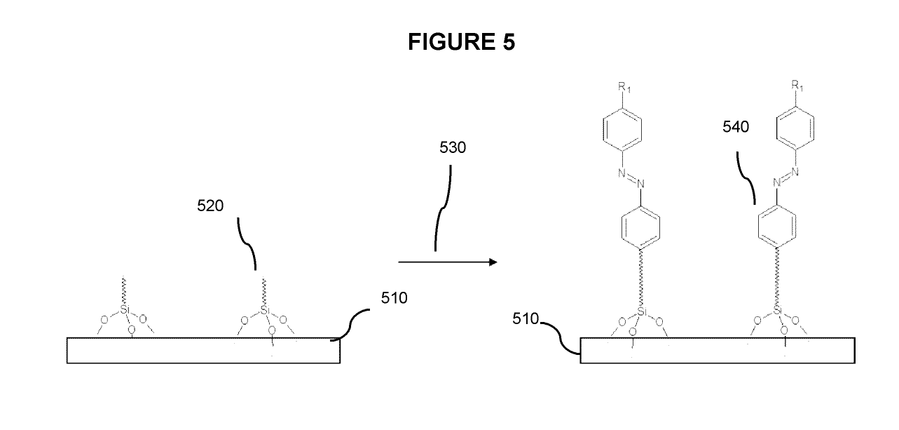

In some embodiments, the refractive-index changeable molecule is van der waals bonded or covalently bonded to a surface of the substrate. In some embodiments, the refractive-index changeable molecule is directly bonded to a substrate through van der waals fours, or covalently bonded to a silicon of a silanized surface of the substrate. FIGS. 3A and 3B illustrates some embodiments of directly bonding a refractive-index changeable molecule to a substrate. FIG. 5 illustrates some embodiments of covalently bonding a refractive-index changeable molecule to a silanized surface of a substrate. A substrate 510 with a silanized surface 520 is shown. A compound containing a refractive-index changeable molecule, for example azobenzene is provided 530. The compound binds to the silanized surface, thus covalently binding a refractive-index changeable molecule 540 to the surface.

In embodiments, a mixed population of refractive-index changeable molecules is provided, in which some molecules are in an trans conformation, and substantially the rest of the molecules are in a cis conformation. In some embodiments, over about 70% of the molecules are in a trans configuration, for example about 70 to 100%.

In some embodiments, the substrate includes a surface of a light emitting diode. In some embodiments, the substrate includes two or more surfaces of a light emitting diode. In some embodiments, the substrate includes surfaces of two or more light emitting diodes. In some embodiments, the substrate is any surface of a lighting device, such as a bulb, diode, tube, etc.

In some embodiments, a luminance-controllable film having a function of reversibly modulating light depending on the unevenness of the light (intensity), is provided by employing a refractive index-changeable composition and/or a phototunable composition, as provided herein. In some embodiments, the refractive index or the refractive index anisotropy of composition can change depending on the intensity of irradiated light. This can cause a change in the optical state, such as scattering/reflection, which allows for luminance adjustment of light emitted through a substrate (for example, to the outside). In some embodiments, the change in the scattering/reflection state can be achieved by changing the light transmittance in a specific direction that occurs due to changes in optical characteristics, such as changes in refractive index and refractive index anisotropy, due to chemical structure modification, such as cis-trans isomerization, caused by light irradiation.

In some embodiments, an isomerizable molecule can be placed between substrates constituting the luminance-controllable film and/or can be immobilized on one or more surface of a sheet. By forming a layer having a high refractive index on one surface of the sheet, it is possible to effectively use not only a change in scattering but also a change in reflection characteristics.

Because the luminance-controllable film guides visible light with extremely high intensity, in some embodiments modifications in the chemical structure described herein use relatively low-intensity ultraviolet (UV) light contained in light from a light source such as an LED.

In some embodiments, in order to accelerate cis-trans isomerization of a liquidcrystal, a liquidcrystalline azobenzene or stilbene derivative having functional groups R¹ and R² can be used. Furthermore, such a derivative can be fixed to a surface of a base material via the functional group R¹ or R² at the end.

In some embodiments, a “flat” molecule such as azobenzene exhibits refractive index anisotropy. For example, polyazo has refractive indices nₑ=1.7 and nₒ=1.5, and the average value nₐᵥ in a random distribution is 1.6. For PVA, n=1.5. In stilbene, the average value nₐᵥ is about 1.622. That is, the refractive index can vary depending on the presence or absence of molecular orientation and, in the case where it has orientation, varies depending on the orientation direction.

In some embodiments, azobenzene and stilbene derivatives show UV-vis absorption as a function of the conjugated systems described herein. Isomerization from the trans-form to the cis-form can proceed by irradiation with light corresponding to the absorption of the trans-form, changing the UV-vis absorption spectrum. The change in absorption wavelength can depend on the types of the introduced functional groups R¹ and R². In some embodiments, a compound is selected that does not have large absorption in the visible light region.

As noted above, in some embodiments, the modification in chemical structure caused by UV irradiation causes a change in refractive index (or refractive index anisotropy). In some embodiments, the luminance of a film can be adjusted by controlling the scattering/reflection of light through changing the refractive index (or refractive index anisotropy) of a refractive-index-changeable material dispersed in the film. The change in scattering can be thought of as a change in Mie scattering or Rayleigh scattering, depending on the size of the dispersed phase. Rayleigh scattering applies to only a case where the size of the particles is much smaller than the wavelength (radius r<0.1,0.1). When a collimated beam of natural light having a wavelength λ and unit irradiance is incident on a dielectric particle, the normal irradiance E, at a distance I from the particle with a scattering angle θ is represented by equation (1) below:

$${E}_{θ} = \frac{{π}^{2} H ( 1 - {cos}^{2} θ )}{{λ}^{4} {l}^{2}} \qquad Equation 1$$

The forward scattering coefficient due to an inorganic dispersed phase uniformly dispersed in a matrix resin is represented by equation (2) below:

$$\begin{matrix}Equation 2 & \\ {C}_{sca} = \frac{8}{3} {( \frac{2 π {n}_{p} r}{λ} )}^{4} \cdot {( \frac{{( \frac{{n}_{p}}{{n}_{m}} )}^{2} - 1}{{( \frac{{n}_{p}}{{n}_{m}} )}^{2} + 2} )}^{2} \cdot π {r}^{2} \\ {α}_{sca} = \frac{3 η {C}_{sca}}{4 π {r}^{3}} & ( 2 )\end{matrix}$$

C_{scα}: Scattering cross-section

nₘ: Refractive index of host material

nₚ: Refractive index of inclusion α_{acα}: Extinction coefficient

r: Radius of inclusion η: Volume fraction of inclusions

λ: Wavelength of propagating light

Accordingly, in the case where a dispersed phase causing Rayleigh scattering is introduced, the change in light intensity of incident light (linear transmittance change) can be approximately expressed by the change in Rayleigh scattering. On the other hand, the scattering cross-section of Mie scattering is represented by equation (3). Actual simulation can be implemented using MiePlot v4.2

$${C}_{Mie} = {( \frac{2 π }{{k}_{host}^{2}} )}^{2} {\sum }_{n = 1}^{∞} ( 2 n + 1 ) ( {\vert 2 n + 1 \vert}^{2} + {\vert {b}_{n} \vert}^{2} ) \qquad Equation 3$$

The reflectance of incident light at an interface can be represented by equation (4).

$$R = {( \frac{{n}_{1} cos {θ}^{′} - {n}_{2} cos θ}{{n}_{1} cos {θ}^{′} + {n}_{2} cos θ} )}^{2} \qquad Equation 4$$

A change in the reflectance can be caused by a change in the difference between n1 and n2. For example, a shielding effect against incident light can be exhibited when the difference is increased by an external stimulus.

### EXAMPLES

### Example 1

### Generation of Scattering by Modifying Anisotropy of Liquid Crystal

A cis-trans isomerizable, phototunable, and vertically oriented nematic liquid crystal is inserted between two sheets. The thickness of the liquid phase layer is several hundreds of nanometers to several hundreds of micrometers. A composition having a refractive index nearly equal to that of the vertically oriented liquid crystal layer (n=about 1.5) is used as the sheets. The nematic phase shifts to become isotropic by UV irradiation, and each layer of the structure is designed so that the refractive index of the sheets is lower than that of the isotropic-liquid crystal layer.

Prior to irradiation with UV, the liquid crystal forms a vertically oriented nematic phase on the surface of the sheets and has a refractive index nearly equal to that of the sheet composition in the incident direction, therefore maintaining transparency.

Upon exposure to UV radiation, the nematic phase shifts to become isotropic through isomerization from the trans-form to the cis-form, causing a change in refractive index in the incident direction of light and also formation of domains serving as scattering centers, in the liquid phase layer. In order to form the scattering centers, it is effective to also include a molecule that is not cis-trans isomerized.

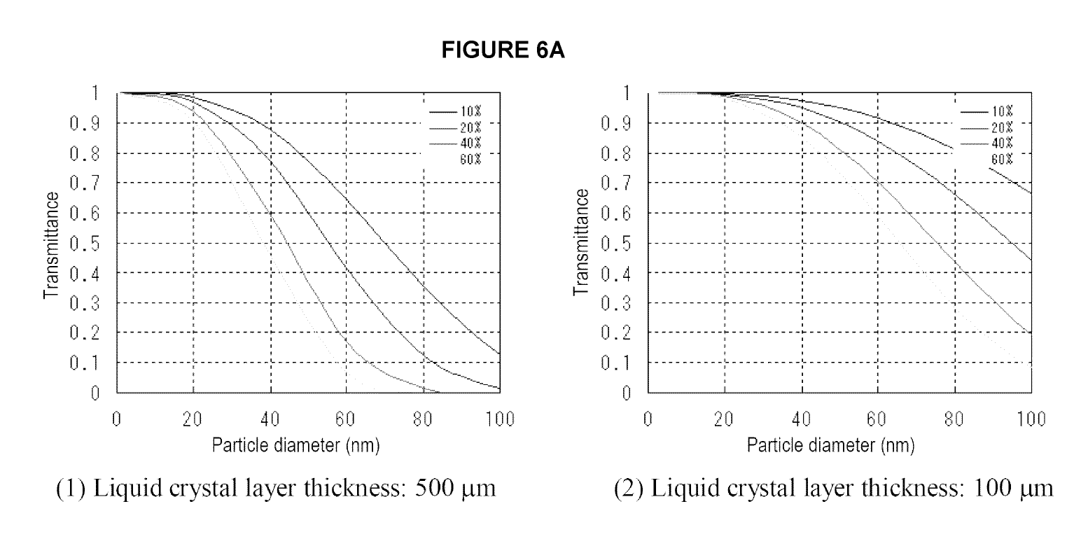

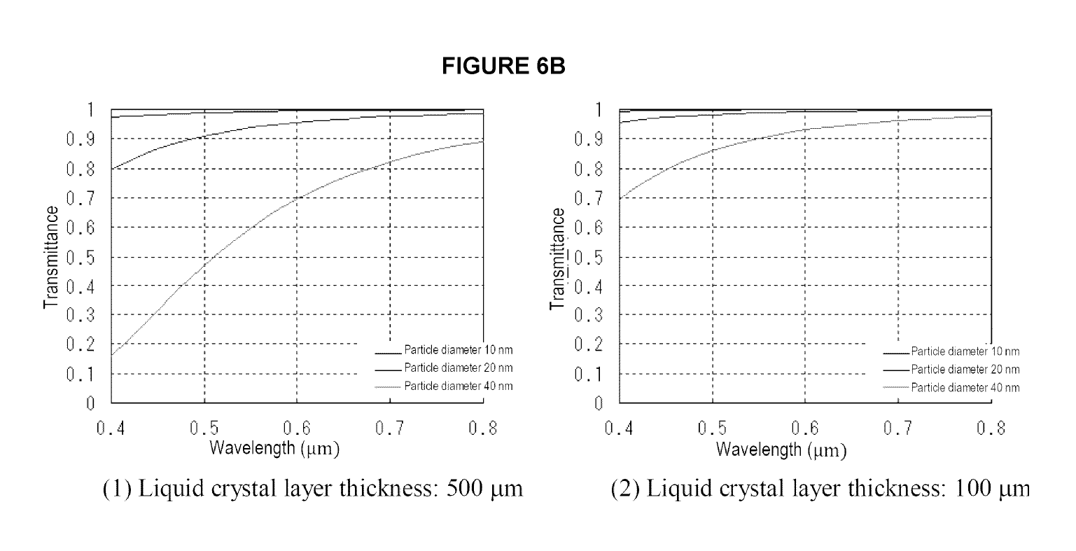

Estimated values of linear transmittance for the domain size, scattering domain diameter, and wavelengths calculated by equation (2) are shown in the graphs of FIG. 6A (for 500 and 100 micron thickness, at 589 nm wavelength visible light) and 6B (for 500 and 100 micron thickness).

### Example 2

### Increase in Reflection by Modification of Anisotropy at Surface of High-Refractive-Index Film

As in Example 1, a phototunable liquid crystal is placed on the surface of a sheet, and a change in transmittance due to phase modification by UV irradiation is used. The refractive index in the incident direction to the nematic phase is designed to be an intermediate value between those of the high-refractive-index layer and the substrate shown (as shown in FIG. 1B). The nematic phase shifts to become isotropic by UV irradiation, and the reflectance at the interface with the high-refractive-index layer is increased, decreasing the amount of transmitted light.

The high-refractive-index layer is a material that is colorless in the visible light region and has a refractive index of not less than 1.76, which is larger than that (n=about 1.7) of the horizontally oriented liquid crystal layer.

The substrate is a composition having a refractive index that is less than that of the horizontally oriented liquid crystal layer (n=about 1.7). Each layer of the structure is designed so that the refractive index of the sheet is less than the refractive index of the horizontally oriented liquid crystal layer, which is less than the refractive index of the high-refractive-index layer.

Upon UV irradiation, the nematic phase shifts to become isotropic and the refractive index of each layer of the structure is such that the refractive index of the substrate is less than or equal to the refractive index of the isotropic-liquid crystal layer, which is less than or equal to the refractive index of the high-refractive-index layer.

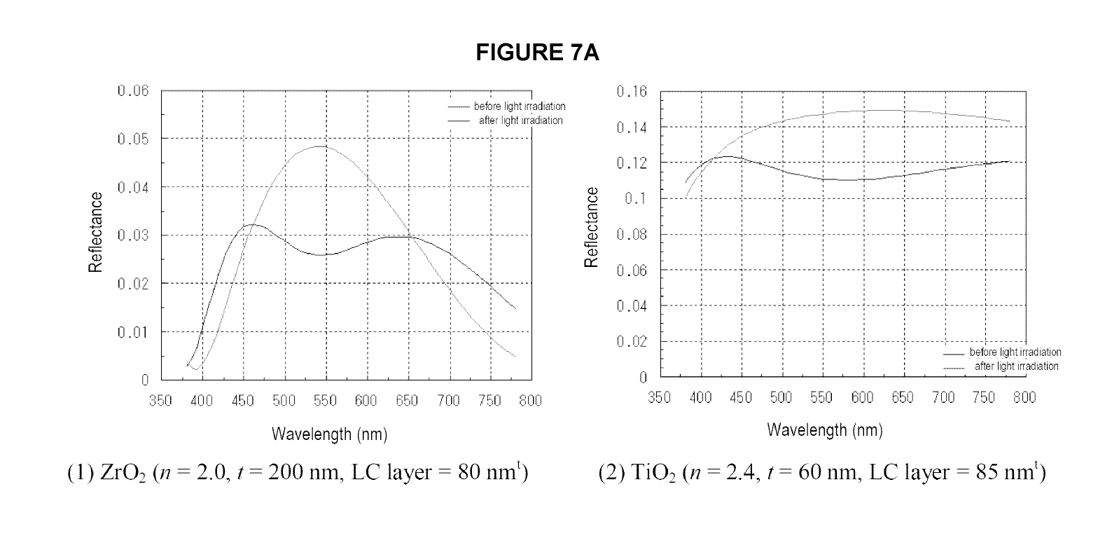

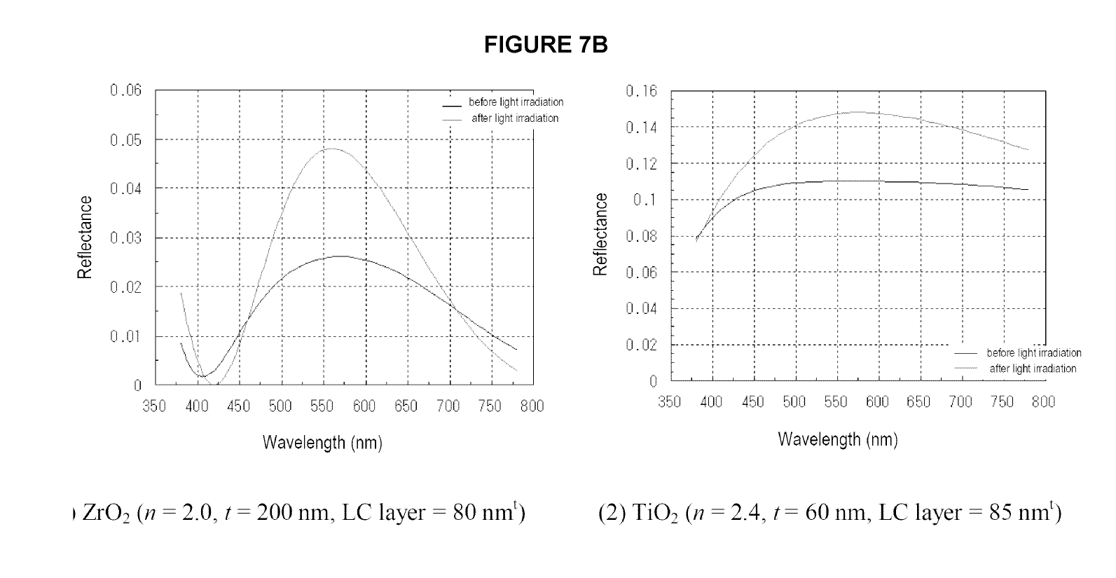

Estimated values of the reflectance by modulation of the liquid crystal orientation at each wavelength calculated by equation (4) are shown in the graphs of FIGS. 7A and 7B. In the case where the high-refractive-index layer is made of ZrO₂ having a refractive index of 2.0, the estimated increase in reflectance by light irradiation is about 2% at a center wavelength of 550 nm; and in the case of TiO₂ having a refractive index of 2.4, the estimated increase in reflectance by light irradiation is about 4% at a center wavelength of 550 nm.

### Example 3

### Fabrication of Luminance-Controllable Sheet

The surfaces of the substrate are treated so as to maintain a vertically oriented state of a liquid crystal, and then a liquid crystal containing azobenzene is placed between the sheets. The azobenzene structure is isomerized from the trans- to the cis-form by UV irradiation to collapse the vertical orientation (See FIG. 3A), resulting in a shift to a random isotropic structure. In addition, a coarse structure, due to steric hindrance, is formed to serve as scattering centers. The further addition of a nematic crystal can increase the size of the coarse structure, enhancing the scattering effect.

The substrate surface is treated with silane having a reactive end, and then a liquid crystal having an azobenzene structure is reacted with the silanized surface to introduce a vertically oriented liquid crystal molecule, thereby providing a luminance-controllable sheet.

### Example 4

### Increase in Reflection by Modification of Anisotropy at the Surface of the Highrefractive-Index Film

A high-refractive-index layer is formed on one surface of a high-refractive-index layer. Four layers can be formed, and each can individually include titanium oxide (n=2.55), zirconium oxide (n=2.17), tin oxide (n=1.998), zinc oxide (n=1.95), and aluminum oxide (n=1.76). These high dielectric films are formed by chemical vapor deposition. The film of TiO₂ and ZrO₂ is formed so as to have a thickness of 80 and 85 nanometers, respectively.

The surface of the sheet is treated so as to maintain a horizontally oriented state of a liquid crystal (rubbing is not required), and then a film is formed by placing a liquid crystal containing azobenzene between the sheet and the high-refractive index-forming sheet in such a manner that the liquid crystal faces the horizontally oriented surface of the sheet (See FIG. 3B). Thus, a horizontally oriented state is ensured.

The azobenzene structure is isomerized from the trans- to the cis-form by UV irradiation to collapse the horizontal orientation, resulting in a shift to a random isotropic structure. Thus, a reduction in refractive index in the incident direction is achieved.

In the horizontally oriented state, the refractive index of the azobenzene-containing liquid crystal, which serves as an antireflective film for the high-refractive-index layer formed on one surface of the sheet, decreases to the same level as that of the sheet (a change of approximately from n=1.7 to n=1.6). This increases the reflectance at the interface with the high-refractive-index layer, resulting in a decrease in the amount of transmitted light. In addition, a coarse structure due to steric hindrance is formed, and scattering centers are also introduced to provide a scattering effect.

### Example 5

### Specific Example of Structure

A liquid crystal mixture of 4-butyl-4′-methoxyazobenzene (AzoLC) having azobenzene as a skeleton and a nematic liquid crystal (5CB) is used. AzoLC is isomerized from the trans- to the cis-form by irradiation with UV light. As a result, the nematic phase shifts to become isotropic. The isotropic phase returns to the nematic phase by irradiation with visible light.

By using these modifications, the change of the scattering/reflection state by UV irradiation described in the above-mentioned models is achieved. The state returns to the initial state via the cis-trans isomerization caused by irradiation with heat or the surrounding visible light when not irradiated with UV light.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A light filter comprising:
a substrate; and
at least one a refractive-index changeable compound on the substrate, wherein the at least one refractive-index changeable compound has a first optical characteristic that changes to a second optical characteristic through a first photoinduced structural modification.

2. The light filter of claim 1, wherein the first optical characteristic is a first refractive index for electromagnetic radiation, and the second optical characteristic is a second refractive index for electromagnetic radiation.

3. The light filter of claim 2, wherein the first refractive index is lower than the second refractive index.

4. (canceled)

5. (canceled)

6. The light filter of claim 2, further comprising a high refractive-index layer, wherein the at least one refractive-index changeable compound is positioned between the substrate and the high refractive-index layer, wherein the second refractive index is less than the first refractive index, wherein the high refractive index layer has a refractive index greater than the first refractive index and greater than the second refractive index, and wherein the substrate has a refractive index less than the first refractive index, and less than or equal to the second refractive index.

7. (canceled)

8. The light filter of claim 1, wherein the first optical characteristic is a first level of optical anisotropy, and the second optical characteristic is second level of optical anisotropy.

9. The light filter of claim 1, wherein the photoinduced structural modification comprises isomerization of at least one molecule of the at least one refractive-index changeable compound from a trans form to a cis form.

10. The light filter of claim 1, wherein the at least one refractive-index changeable compound comprises molecules, and wherein the photoinduced structural modification comprises isomerization of at least 30% of the molecules of the at least one refractive-index changeable compound from a trans form to a cis form.

11. The light filter of claim 1, wherein the photoinduced structural modification is induced by ultraviolet electromagnetic radiation.

12. The light filter of claim 1, wherein the at least one refractive-index changeable compound comprises at least one of: 9-demethylretinal, derivatives of 9-demethylretinal, an azobenzene, an azobenzene derivative, a stilbene, a stilbene derivative, the compound of formula I, or the compound of formula II. 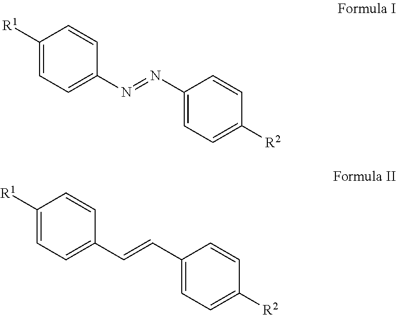
wherein R¹ and R² can each be independently selected from the group of at least one of the following: a hydrogen, an alkyl, an alkoxyl a hydroxyl, a hydroxylalkyl, a cyano and a silanol group.

13. The light filter of claim 1, wherein the second optical characteristic is capable of being reverted to the first optical characteristic through a second photoinduced structural modification or thermal structural modification.

14. An illuminated device comprising:
a phototunable compound, wherein the phototunable compound has a first optical characteristic that changes to a second optical characteristic through photoinduced structural modification; and
a source of electromagnetic radiation positioned to provide light to the phototunable compound.

15. The illuminated device of claim 14, wherein the source of electromagnetic radiation is a light emitting diode.

16. A method of manipulating at least one wavelength of visible wavelength radiation, the method comprising:
controlling an optical property of a phototunable compound at a first wavelength of visible light by irradiating the phototunable compound with at least one wavelength of ultraviolet radiation,
wherein the phototunable compound is positioned on top of a substrate, and
wherein the substrate is substantially transparent to ultraviolet radiation and visible light.

17. The method of claim 16, wherein the irradiating of the phototunable compound comprises providing ultraviolet radiation.

18. The method of claim 16, wherein the irradiating of the phototunable compound comprises providing infrared radiation.

19. The method of claim 16, wherein the optical property of the phototunable compound comprises a refractive index.

20. The method of claim 16, wherein the optical property of the phototunable compound comprises anisotropy.

21. The method of claim 16, wherein the phototunable compound comprises a refractive index-changeable compound.

22. The method of claim 21, wherein the refractive index-changeable compound comprises at least one of: an azobenzene, an azobenzene derivative, a stilbene, and a stilbene derivative.

23. (canceled)

24. The method of claim 16, wherein the phototunable compound is embedded in the substrate.

25. The method of claim 16, wherein the phototunable compound is positioned between the substrate and a high refractive-index layer.

26. The method of claim 16, wherein controlling an optical property of the phototunable compound comprises modulating scattering by the phototunable compound.

27. (canceled)

28. The method of claim 16, wherein a first irradiation modulates the optical property from a first state to a second state, and wherein a second irradiation modulates the optical property from the second state to the first state.

29. A visible wavelength light manipulator comprising:
a substrate, wherein the substrate is substantially transparent to electromagnetic radiation traveling in at least one incident direction; and
at least one refractive-index changeable molecule covalently bonded to a surface of the substrate.

30. The visible wavelength light manipulator of claim 29, wherein the at least one refractive-index changeable molecule comprises a layer of refractive-index changeable molecules, and wherein the layer covers at least a portion of the surface.

31. (canceled)

32. (canceled)

33. The visible wavelength light manipulator of claim 30, wherein at least 95% of refractive-index changeable molecules of the layer are in a trans conformation.

34. The visible light manipulator of claim 30, wherein the layer is about 0.1 micrometer to about 500 micrometers in thickness.

35. (canceled)

36. (canceled)

37. The visible light manipulator of claim 29, wherein the surface of the substrate is silanized.

38. (canceled)

39. The visible wavelength light manipulator of claim 29, wherein the substrate is a surface of a light emitting diode.
